(19) United States
(12) Patent Application Publication
(10) Pub. No.: US 2008/0150985 A1
(43) Pub. Date: Jun. 26, 2008

(54) Disc drive apparatus and disc printing method

(75) Inventors: Yuichiro Ikemoto, Kanagawa (JP); Tatsumi Ito, Kanagawa (JP); Takeshi Matsui, Tokyo (JP); Koji Ashizaki, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/002,558

(22) Filed: Dec. 18, 2007

(30) Foreign Application Priority Data
Dec. 26, 2006 (JP) JP2006-350110

(51) Int. Cl. B41J 29/38; G11B 3/64

(52) U.S. Cl. 347/11; 369/84

(57) ABSTRACT

A disc drive apparatus includes: a rotational driving unit rotating a disc-shaped recording medium; a recording and/or reproducing unit recording and/or reproducing an information signal on the information recording surface of the disc-shaped recording medium; a print head printing visible information onto a label surface of the disc-shaped recording medium; and a pulse signal generating unit detecting rotation of the rotational driving unit and generating a pulse signal. Further, the apparatus includes a signal processing unit generating a specified address signal where a pulse is generated when a specified address on the disc-shaped recording medium is reproduced; and a control unit carrying out, based on the pulse signal and the specified address signal, disc correlating processing correlating a disc base position where the specified address is recorded on the disc-shaped recording medium and the pulse signal to obtain position information for the disc-shaped recording medium from the pulse signal.

### CROSS REFERENCES TO RELATED APPLICATIONS

The present invention contains subject matter related to Japanese Patent Application JP 2006-350110 filed in the Japanese Patent Office on Dec. 26, 2006, the entire contents of which being incorporated herein by reference.

### BACKGROUND OF THE INVENTION

1. Field of the Invention

The present invention relates to a disc drive apparatus that is capable of recording information on an information recording surface of a disc-shaped recording medium and also capable of printing visible information such as characters and designs by emitting ink droplets onto a label surface of a disc-shaped recording medium that is being rotated, and also to a disc printing method that uses such disc drive apparatus.

2. Description of the Related Art

An existing example of this type of disc drive apparatus is disclosed by Japanese Unexamined Patent Application Publication No. 2006-244601. This Patent Document discloses an optical disc printing apparatus that prints characters, designs, and the like on the label surface of an optical disc. The optical disc printing apparatus disclosed by this Patent Document includes obtaining means for obtaining print data, print means for printing on the label surface of an optical disc, scanning means for scanning the recording surface of the optical disc, and standard position specifying means for specifying a standard position that is decided in advance on the optical disc. Further, the apparatus includes number-of-data specifying means for scanning the recording surface of the optical disc using the scanning means and detecting boundary regions disposed at boundaries between sets of actual data that have been recorded on the recording surface to specify the number of actual data that have been recorded on the recording surface. Furthermore, the apparatus includes print region specifying means that specifies, based on the standard position, print regions disposed at suitable positions for the number of actual data specified by the number-of-data specifying means out of a plurality of print regions disposed at determined positions on the label surface of the optical disc, and print control means for causing the print means to print in the specified print regions based on the print data obtained by the obtaining means.

The optical disc printing apparatus disclosed in Japanese Unexamined Patent Application Publication No. 2006-244601 with the construction described above has a stated effect of making it possible to print a plurality of times on the label surface of an optical disc (see Paragraph [0006]).

Another example of this type of related-art disc drive apparatus is disclosed in Japanese Unexamined Patent Application Publication No. 2004-192735. This Patent Document describes an optical disc recording apparatus equipped with a print function. The optical disc recording apparatus disclosed in this Patent Document is an optical disc recording apparatus that records information on an optical disc that has a label and includes label printing means that prints on the label of the optical disc.

The optical disc recording apparatus disclosed in Japanese Unexamined Patent Application Publication No. 2004-192735 with the construction described above has a stated effect as follows. Accordingly, it is possible to quickly and easily complete a series of operations from the recording of images, music, and the like to label printing with a single appliance, without having to carry out a complicated operation of newly setting an optical disc in a printer for label printing after data has been optically recorded on the optical disc and/or inputting information on the content to be printed, for example, information on the title, cast, and notable scenes.

However, in the optical disc printing apparatus disclosed in Japanese Unexamined Patent Application Publication No. 2006-244601, a plurality of print regions are set in advance on the label surface of the optical disc and the order for printing in such plurality of print regions is also determined in advance. This optical disc printing apparatus is constructed so that by stopping the rotation of the optical disc at the same time as the pickup unit detects a lead-in recorded at the start of the recording surface and keeping the relative positions of the respective print regions constant, additional printing on the label surface becomes possible. Accordingly, there are limitations on the print regions and it has not been possible to optionally set the sizes and positions of the print regions.

Also, for the optical disc recording apparatus disclosed in Japanese Unexamined Patent Application Publication No. 2004-192735, printed regions and blank regions are identified by scanning markings provided in the outermost periphery of the label surface using a marking sensor, and data recorded in the outermost periphery of the information recording surface of the optical disc is read by the pickup unit and the output of the pickup unit is used as position data. With this construction, both types of data are correlated to grasp the positions of the printed regions on the optical disc, thereby making further printing possible on the label surface. Accordingly, it may be necessary to print markings corresponding to the regions that have been printed on the outermost periphery of the label surface, resulting in the problems of the operation taking more time and of deterioration in the appearance of the label surface.

### SUMMARY OF THE INVENTION

It is desirable to provide a disc drive apparatus in which if additional printing is enabled, the print regions may not be restricted and it is possible to optionally set the size and positions of the print regions. It is also desirable that markings may not be provided on the label corresponding to printed regions, and print operations may not take time and there may be no deterioration in the appearance of the label surface.

According to an embodiment of the present invention, there is provided a disc drive apparatus including: a rotational driving unit, a recording and/or reproducing unit, a print head, a pulse signal generating unit, a signal generating unit, and a control unit. The rotational driving unit rotates a disc-shaped recording medium, in which a plurality of addresses have been recorded on an information recording surface of the disc-shaped recording medium. The recording and/or reproducing unit carries out recording and/or reproduction of an information signal on the information recording surface of the disc-shaped recording medium rotated by the rotational driving unit. The print head prints visible information by ejecting ink droplets onto a label surface of the disc-shaped recording medium rotated by the rotational driving unit. The pulse signal generating unit detects rotation of the rotational driving unit and generates a pulse signal. The signal processing unit generates a specified address signal in which a pulse is generated when a specified address on the disc-shaped recording medium is reproduced by the recording and/or reproducing unit. The control unit carries out, based on the pulse signal and the specified address signal, disc correlating processing that correlates a disc base position at which the specified address is recorded on the disc-shaped recording medium and the pulse signal to obtain position information for the disc-shaped recording medium from the pulse signal.

According to another embodiment of the present invention, there is provided a disc printing method that prints visible information by rotating a disc-shaped recording medium, on an information recording surface of which a plurality of addresses have been recorded, using a rotational driving unit and ejecting ink droplets onto a label surface of the disc-shaped recording medium. This disc printing method includes the steps of:

detecting rotation of the rotational driving unit and outputting a pulse signal;

outputting a specified address signal in which a pulse is generated when a specified address on the disc-shaped recording medium is reproduced;

carrying out, based on the pulse signal and the specified address signal, disc correlating processing that correlates a disc base position at which the specified address is recorded on the disc-shaped recording medium and the pulse signal;

obtaining position information for the disc-shaped recording medium from the pulse signal based on a processing result of the disc correlating process; and

printing visible information on the label surface based on the position information of the disc-shaped recording medium.

According to an embodiment of the disc drive apparatus and disc printing method of the present invention, even if a disc-shaped recording medium is repeatedly ejected and loaded, it will be possible at any time to grasp the absolute position of the disc-shaped recording medium, so that additional printing can be carried out on the label surface without providing position detection markings or the like on the label surface.

### BRIEF DESCRIPTION OF THE DRAWINGS

FIG. 1 is a block diagram showing a first embodiment of a disc drive apparatus according to the present invention.

FIG. 2 is a diagram provided for explaining a pulse generating unit in the first embodiment of a disc drive apparatus according to the present invention.

FIG. 3 is a diagram provided for explaining an encoder disc of the pulse generating unit in the first embodiment of a disc drive apparatus according to the present invention.

FIG. 4 is a flowchart showing a procedure that detects the relative positions of the disc-shaped recording medium and the pulse generating unit in the first embodiment of a disc drive apparatus according to the present invention.

FIG. 5 is a diagram provided for explaining an encoder signal outputted by the pulse generating unit and a specified address signal generated by a signal processing unit in the first embodiment of a disc drive apparatus according to the present invention.

FIGS. 6A and 6B are diagrams provided for explaining additional printing by the disc drive apparatus according to an embodiment of the present invention, with FIG. 6A showing a state where visible information that is approximately fan-shaped has been printed on the disc-shaped recording medium and FIG. 6B showing a state where visible information that is approximately fan-shaped has been additionally printed on the disc-shaped recording medium shown in FIG. 6A.

FIGS. 7A and 7B are diagrams provided for explaining additional printing by the disc drive apparatus according to an embodiment of the present invention, with FIG. 7A showing a state where rectangular visible information has been printed on the disc-shaped recording medium and FIG. 7B showing a state where two sets of rectangular visible information have been additionally printed on the disc-shaped recording medium shown in FIG. 7A.

FIG. 8 is a block diagram showing a second embodiment of a disc drive apparatus according to the present invention.

FIG. 9 is a flowchart showing a procedure that detects relative positions of a rotational driving unit and a disc-shaped recording medium according to the second embodiment of a disc drive apparatus according to the present invention.

FIG. 10 is a diagram provided for explaining an FG pulse signal outputted from a pulse generating unit and a specified address signal generated by a signal generating unit according to the second embodiment of the disc drive apparatus according to the present invention.

FIG. 11 is a diagram provided for explaining a pulse generating unit according to a third embodiment of a disc drive apparatus according to the present invention.

FIG. 12 is a diagram provided for explaining an encoder disc of the pulse generating unit according to the third embodiment of a disc drive apparatus according to the present invention.

FIG. 13 is a flowchart showing a procedure that detects relative positions of the pulse generating unit and the disc-shaped recording medium according to the third embodiment of a disc drive apparatus according to the present invention.

FIG. 14 is a diagram provided for explaining an encoder signal outputted from the pulse generating unit and a specified address signal generated by a signal generating unit according to the third embodiment of the disc drive apparatus according to the present invention.

### DESCRIPTION OF THE PREFERRED EMBODIMENTS

A disc drive apparatus and a disc printing method that can carry out additional printing are obtained by a simple construction. Such apparatus and method carry out disc correlating processing that correlates a disc base position and a pulse signal to obtain position information for the disc-shaped recording medium from the pulse signal and can therefore specify an absolute position of the disc-shaped recording medium without providing position detection markings on the label surface of the disc-shaped recording medium.

Although preferred embodiments of a disc drive apparatus and a disc printing method will now be described with reference to the attached drawings, the present invention is not limited to such embodiments.

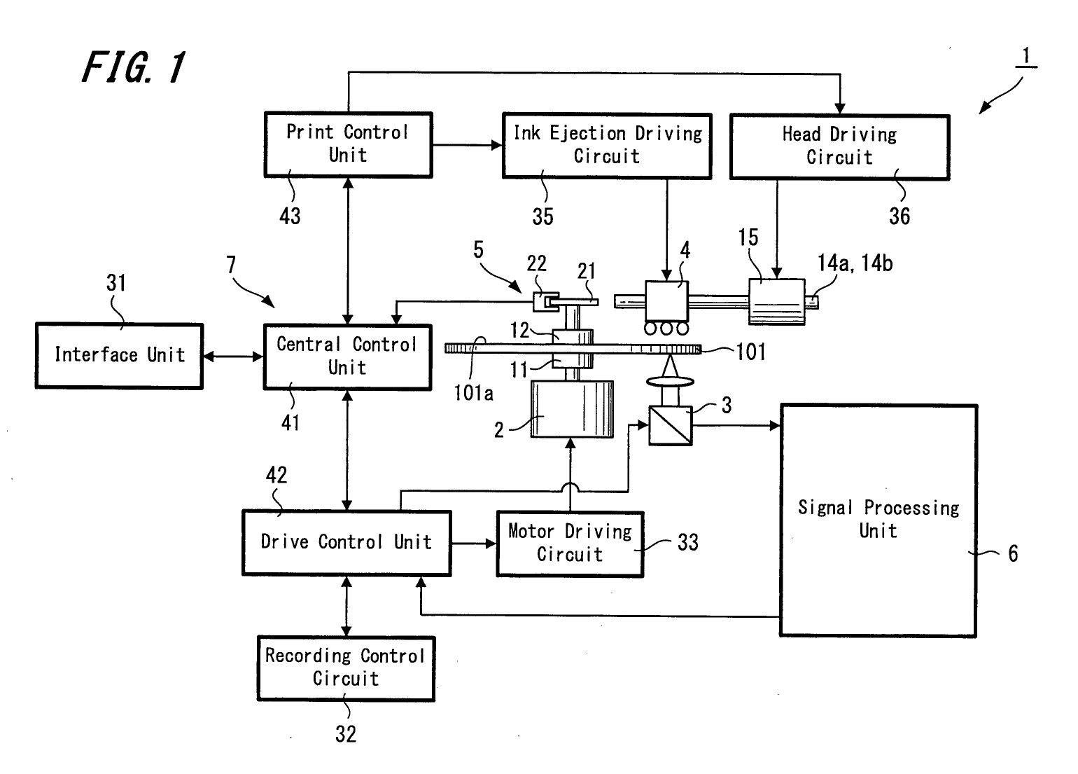

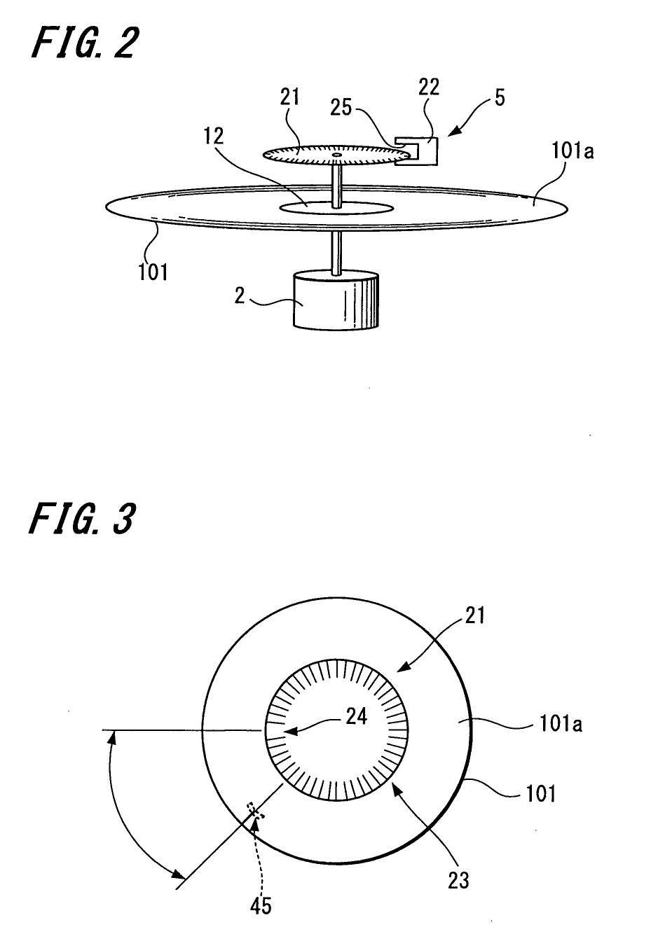

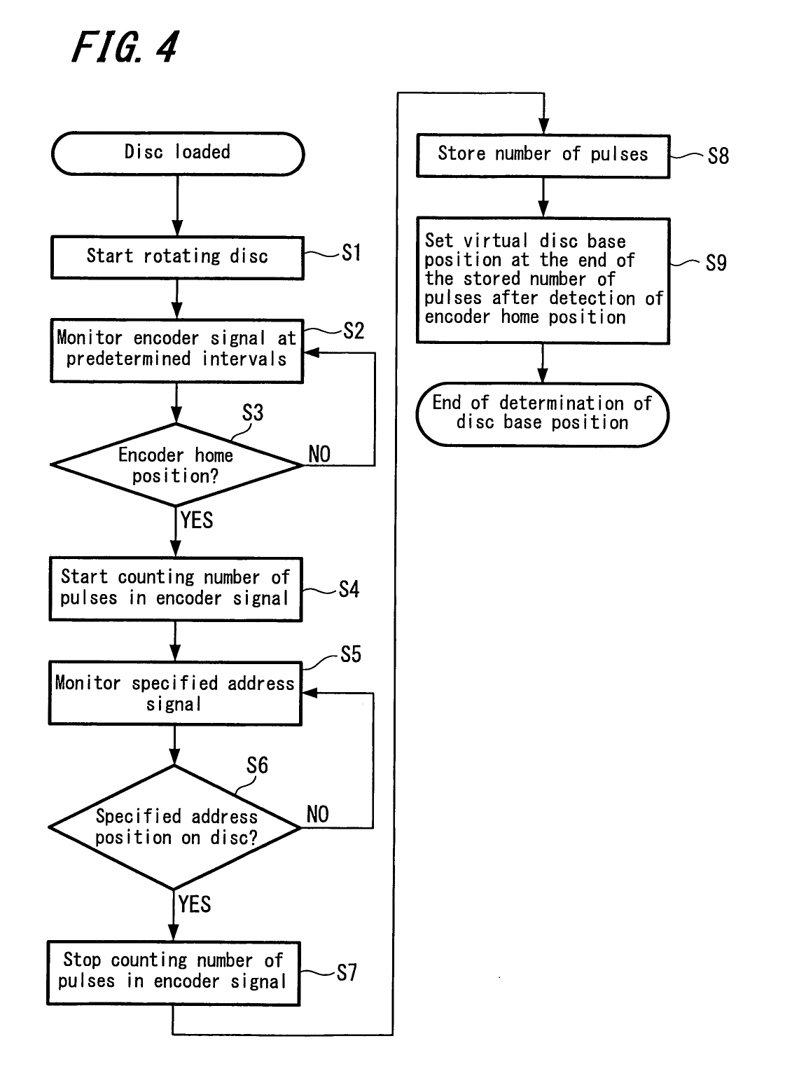

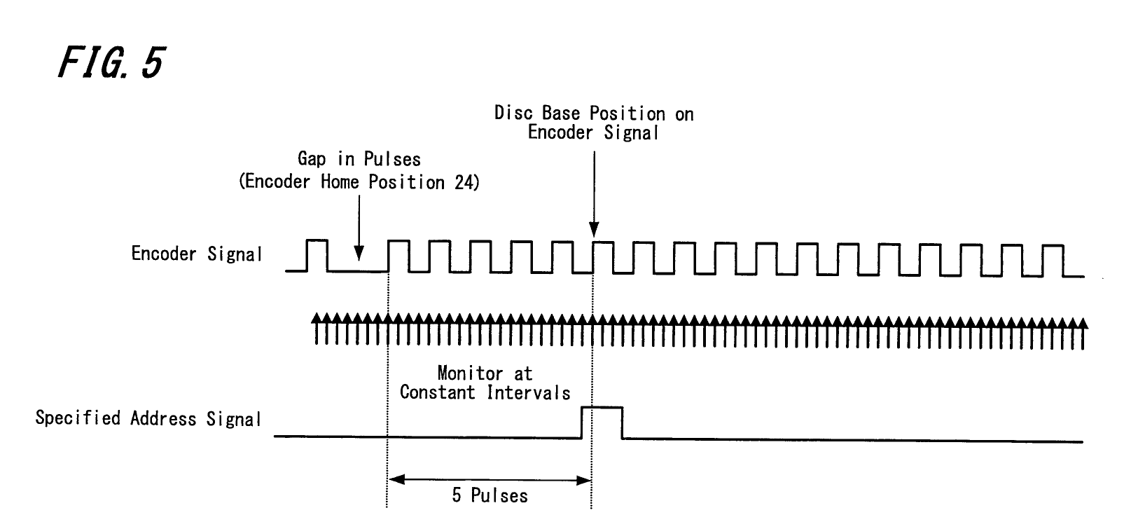

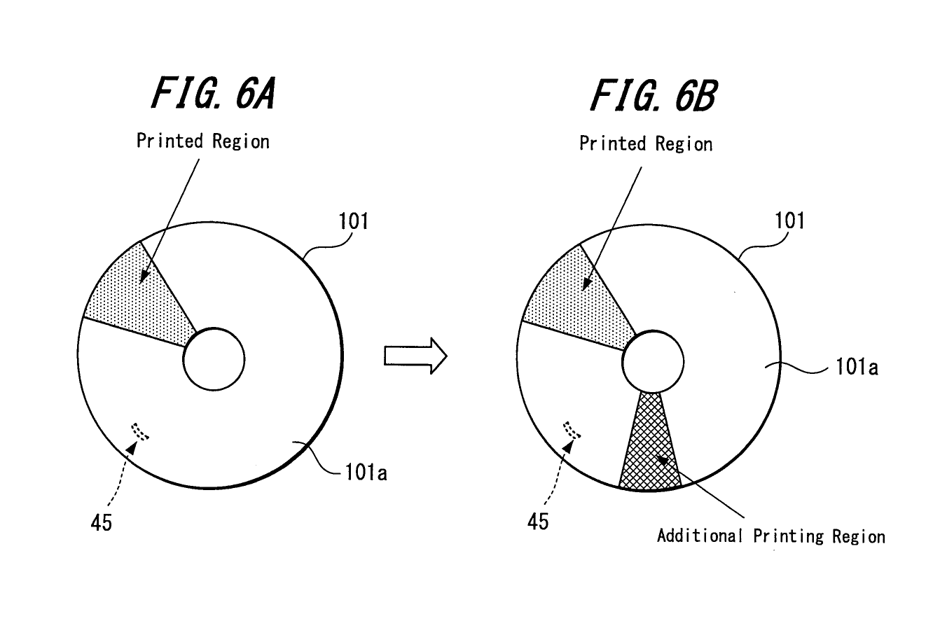

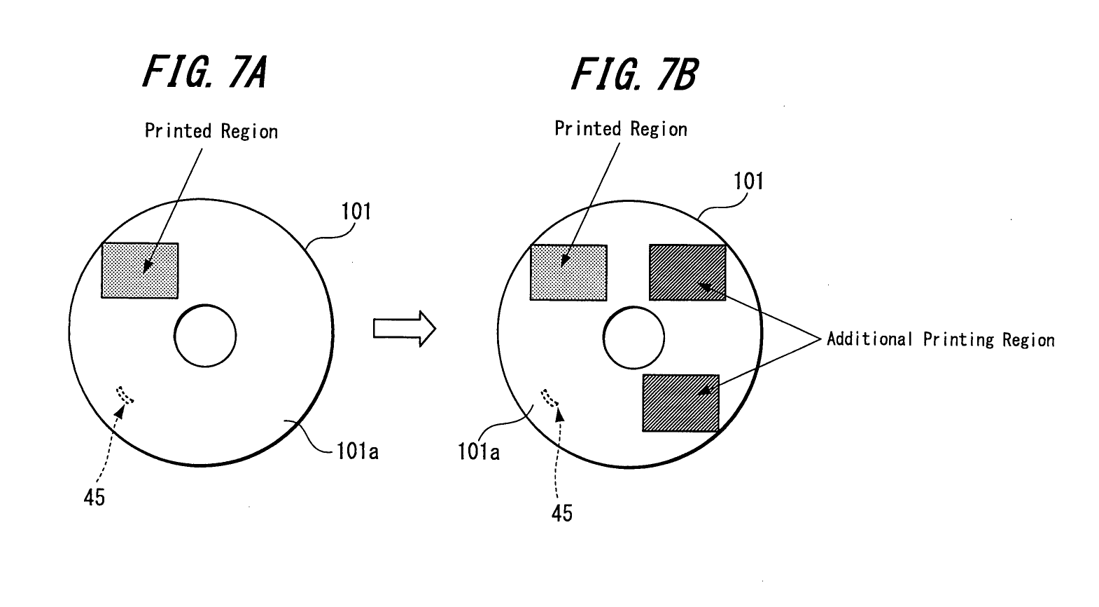

FIGS. 1 to 14 show embodiments of the present invention. FIGS. 1 to 5 show a first embodiment of a disc drive apparatus according to the present invention. FIG. 1 is a block diagram showing the construction of the disc drive apparatus. FIG. 2 is a diagram provided for explaining a pulse generating unit shown in FIG. 1. FIG. 3 is a diagram provided for explaining an encoder disc of the pulse generating unit. FIG. 4 is a flowchart showing a procedure that detects the position of a disc-shaped recording medium relative to the pulse generating unit. FIG. 5 is a diagram provided for explaining a pulse signal outputted by the pulse generating unit and a specified address signal generated by a signal processing unit. FIGS. 6 and 7 are diagrams provided for explaining additional printing.

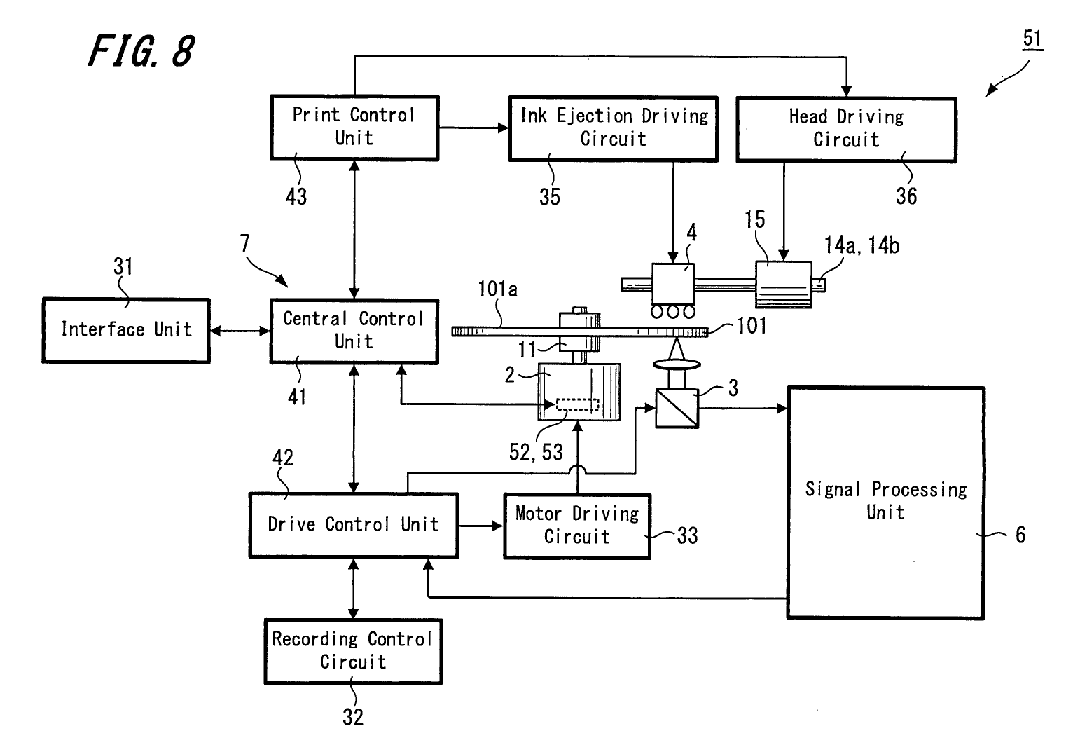

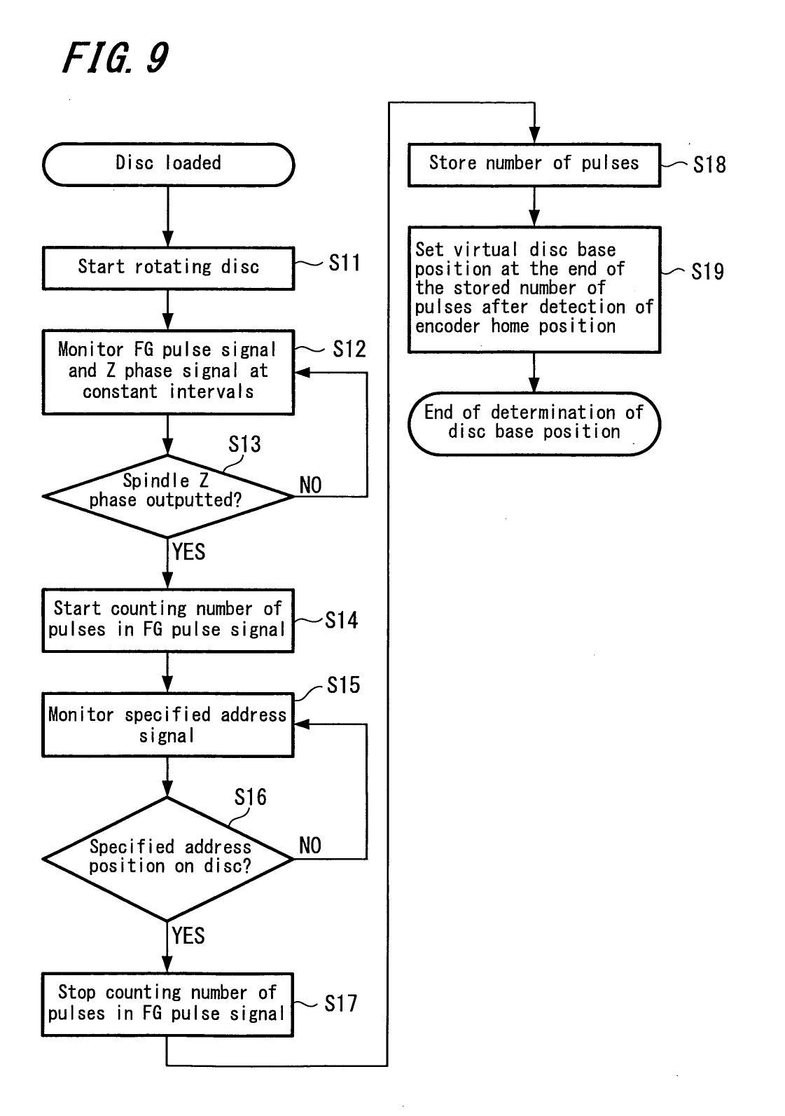

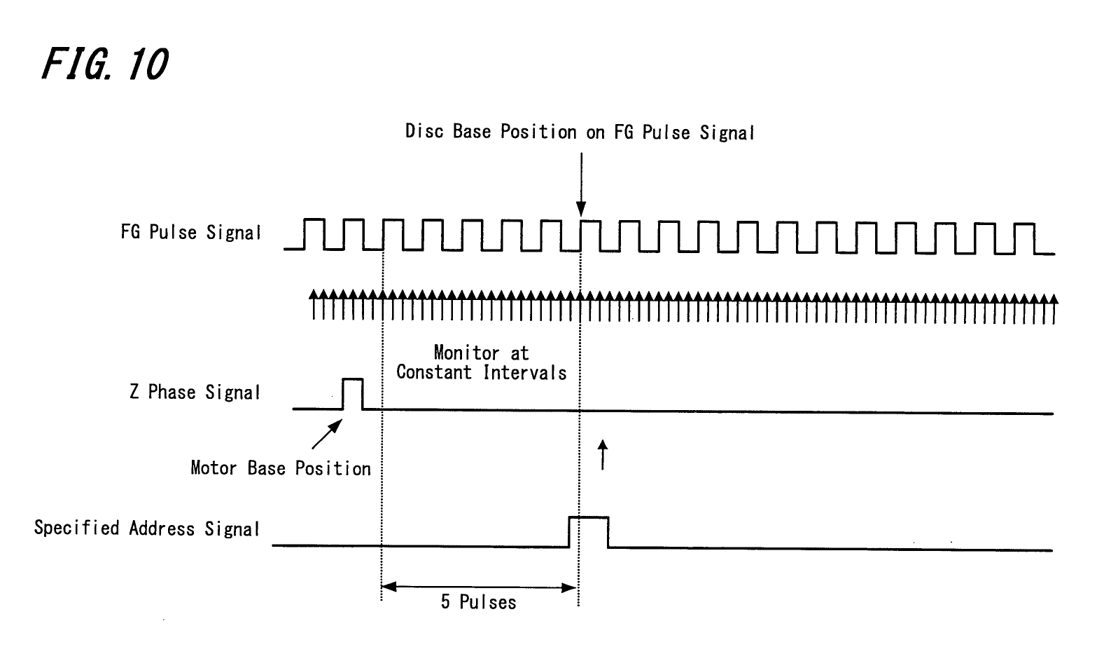

FIGS. 8 to 10 show a second embodiment of a disc drive apparatus according to the present invention. FIG. 8 is a block diagram showing the construction of the disc drive apparatus. FIG. 9 is a flowchart showing a procedure that detects the position of a disc-shaped recording medium relative to the pulse generating unit. FIG. 10 is a diagram provided for explaining a pulse signal outputted by the pulse generating unit and a specified address signal generated by a signal processing unit.

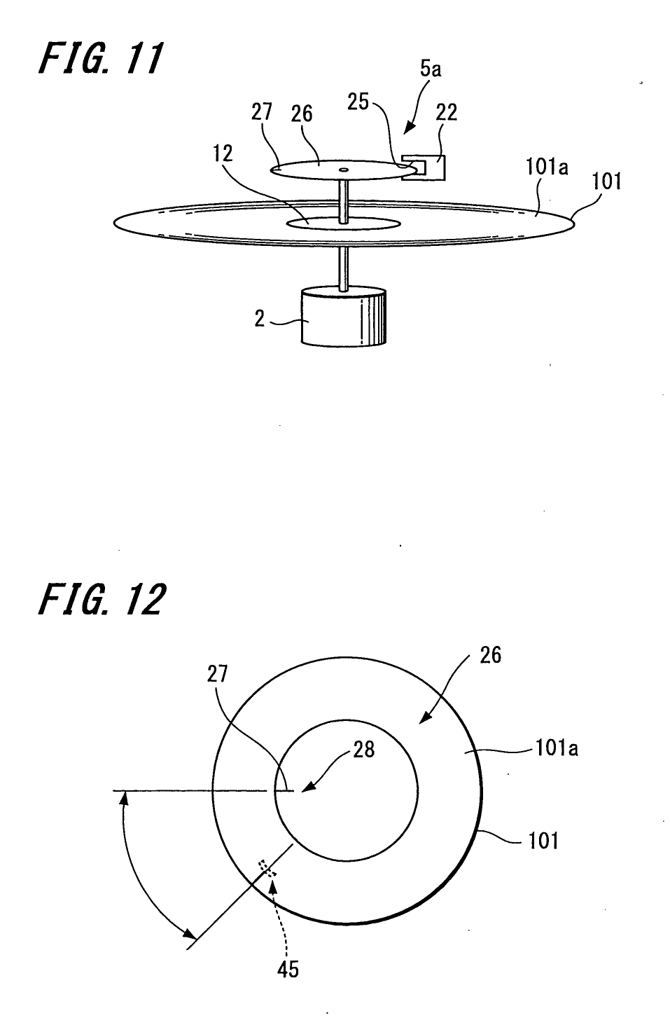

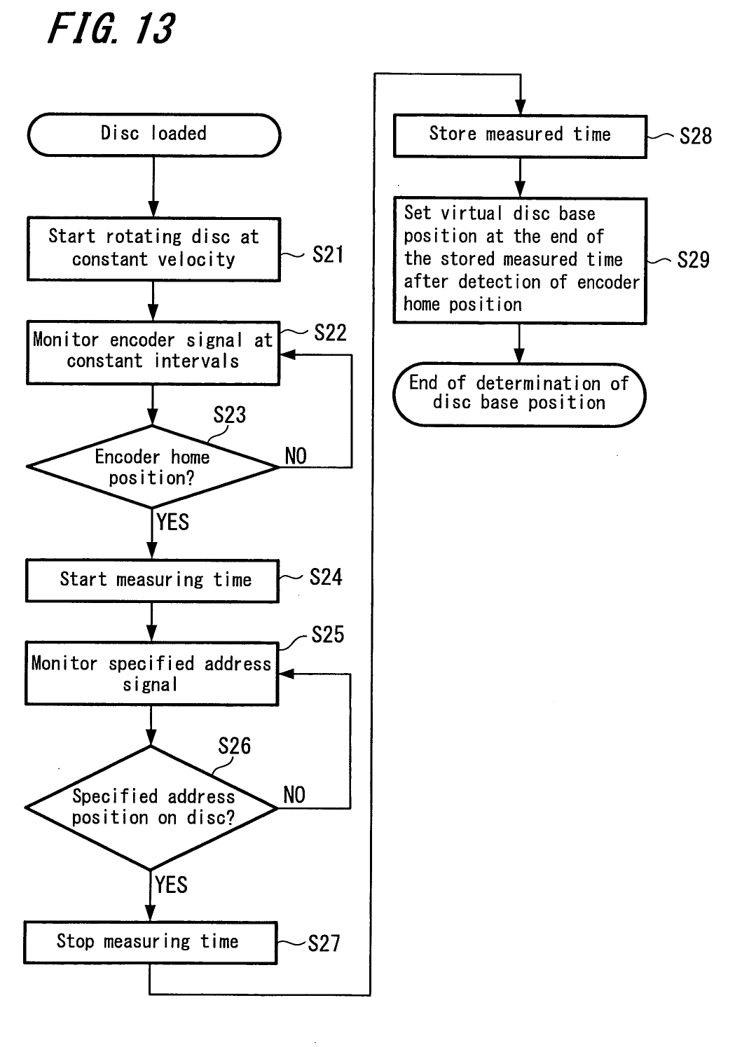

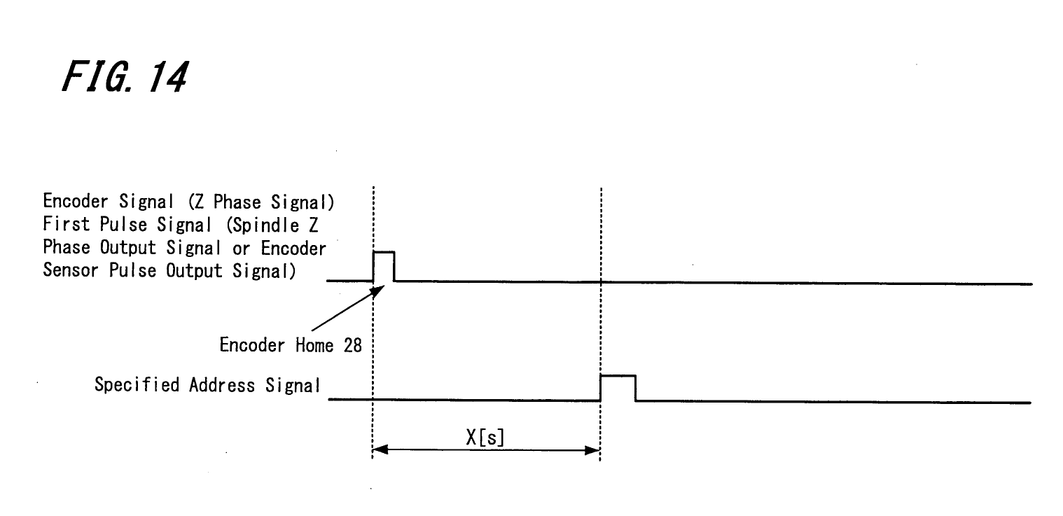

FIGS. 11 to 14 show a third embodiment of a disc drive apparatus according to the present invention. FIG. 11 is a diagram provided for explaining a pulse generating unit according to the third embodiment of a disc drive apparatus. FIG. 12 is a diagram provided for explaining an encoder disc of the pulse generating unit shown in FIG. 11. FIG. 13 is a flowchart showing a procedure that detects the position of a disc-shaped recording medium relative to the pulse generating unit. FIG. 14 is a diagram provided for explaining a pulse signal outputted by the pulse generating unit and a specified address signal generated by a signal processing unit.

A disc drive apparatus 1 shown in FIG. 1 newly records (writes) an information signal on an information recording surface of an optical disc 101 that is a specific example of a disc-shaped recording medium such as a CD-R (Compact Disc-Recordable) or a DVD-RW (Digital Versatile Disc-Rewritable), and reproduces (reads) an information signal recorded in advance. The disc drive apparatus 1 is also capable of printing visible information such as characters and designs on a label surface 101a of the optical disc 101.

As shown in FIG. 1, the disc drive apparatus 1 includes a spindle motor 2 that is a specific example of a rotational driving unit that rotates the optical disc 101, an optical pickup 3 that is a specific example of a recording and/or reproducing unit that writes and/or reads information on the information recording surface of the optical disc 101 rotated by the spindle motor 2, and a print head 4 that prints visible information such as characters and images by ejecting ink droplets onto the label surface 101a of the rotating optical disc 101. Further, the disc drive apparatus 1 includes an encoder 5 that is a specific example of a pulse signal generating unit that generates a pulse signal in accordance with rotation of the rotational driving unit, a signal processing unit 6, and a control unit 7 that controls the optical pickup 3 and the print head 4.

A turntable 11 is provided at a front end of the rotational shaft of the spindle motor 2. The turntable 11 includes a disc engagement portion that detachably engages a center hole of the optical disc 101. By attaching the disc engagement portion to the center hole of the optical disc 101, the optical disc 101 can rotate together with the turntable 11. By rotationally driving the spindle motor 2, the optical disc 101 is rotated together with the turntable 11.

A chucking plate 12 that presses the optical disc 101 on the turntable 11 from above is provided above the spindle motor 2. The chucking plate 12 is rotatably supported by a support plate, not shown, and rotates together with the rotated optical disc 101. Hence, the optical disc 101 becomes sandwiched between the chucking plate 12 and the turntable 11, thereby preventing the disc engagement portion of the turntable 11 from coming out of the center hole of the optical disc 101.

The optical pickup 3 includes a light detector module, an objective lens, and a biaxial actuator that moves the objective lens so as to face the information recording surface (i.e., the opposite surface to the label surface 101a) of the optical disc 101. The optical pickup 3 has a light beam emitted from the light detector module, focuses the light beam onto the information recording surface of the optical disc 101 using the objective lens, and receives a return light beam that has been reflected by the information recording surface via the light detector module. Accordingly, the optical pickup 3 can record (write) an information signal or reproduce (read) an information signal that has previously been recorded on the information recording surface.

The optical pickup 3 is mounted on a pickup base, not shown, and moves together with the pickup base. The pickup base can be moved in the radial direction of the optical disc 101 by a pickup moving mechanism including a pickup motor, not shown. When the pickup base moves, the optical pickup 3 records an information signal on the information recording surface of the optical disc 101 or reproduces an information signal that has been recorded on the information recording surface.

As one example, it is possible to use a feed screw mechanism as the pickup moving mechanism that moves the pickup base. However, the pickup moving mechanism for the embodiment of the present invention is not limited to a feed screw mechanism, and as other examples, it is also possible to use a rack and pinion mechanism, a belt feed mechanism, a wire feed mechanism, or other type of mechanism.

The print head 4 is positioned opposite the label surface 101a of the optical disc 101. Although not shown, a plurality of ejection nozzles that eject ink droplets are provided on a surface of the print head 4 that faces the label surface 101a. The plurality of ejection nozzles of the print head 4 are constructed of nozzle groups that eject ink droplets of a predetermined color. In the present embodiment, four nozzle groups formed of a cyan nozzle group that ejects cyan (C) ink droplets, a magenta nozzle group that ejects magenta (M) ink droplets, a yellow nozzle group that ejects yellow (Y) ink droplets, and a black nozzle group that ejects black (K) ink droplets are provided.

Two guide shafts 14a, 14b that are parallel are slidably inserted through the print head 4. The two guide shafts 14a, 14b extend in the radial direction of the optical disc 101 and both ends thereof in the axial direction are fixed to a guide shaft support member. The print head 4 can be moved along the two guide shafts 14a, 14b by a head moving mechanism including a head driving motor 15. However, as with the pickup moving mechanism, a feed screw mechanism, a rack and pinion mechanism, a belt feed mechanism, a wire feed mechanism, or other type of mechanism can be used as the head moving mechanism.

As shown in FIGS. 2 and 3, the encoder 5 includes an encoder disc 21 that is fixed to the rotational shaft of the chucking plate 12 that rotates together with the spindle motor 2 and an encoder sensor 22 that is disposed outside the encoder disc 21 in the radial direction thereof.

The encoder disc 21 is formed of a thin disc and a center thereof is fixed to the rotational shaft of the chucking plate 12. A plurality of slits 23 that extend in the radial direction and are disposed at predetermined intervals in the circumferential direction (i.e., the direction of rotation of the spindle motor 2) are provided in the encoder disc 21. A gap where no slits 23 are formed at positions the predetermined intervals apart is also provided on the encoder disc 21, with such gap being used as an encoder home position 24 as one example of a base position for the pulse signal generating unit.

The encoder sensor 22 includes a sensing unit 25 at a position facing the slits 23 of the encoder disc 21. When the encoder disc 21 is rotated in synchronization with the spindle motor 2, the sensing unit 25 detects the plurality of passing slits 23 and generates an encoder signal that is a first specific example of a pulse signal. That is, the encoder signal is a signal where a pulse is outputted whenever the spindle motor 2 rotates by a predetermined angle. The encoder sensor 22 outputs the generated encoder signal to a central control unit 41.

The disc drive apparatus 1 also includes the signal processing unit 6, the control unit 7, an interface unit 31, a recording control circuit 32, a motor driving circuit 33, an ink ejection driving circuit 35, and a head driving circuit 36.

The interface unit 31 is a connector that electrically connects an external apparatus, such as a personal computer, and the disc drive apparatus 1. The interface unit 31 outputs signals supplied from the external apparatus to the control unit 7 and outputs signals supplied from the control unit 7 to the external apparatus. As examples, the signals supplied from the external apparatus can be a recording data signal corresponding to recording information to be recorded on the information recording surface of the optical disc 101 and an image data signal corresponding to visible information to be printed on the label surface 101a of the optical disc 101. Also as one example, the signal supplied from the control unit 7 can be a reproduced data signal read from the information recording surface of the optical disc 101.

The control unit 7 is formed of the central control unit 41, a drive control unit 42, and a print control unit 43. The central control unit 41 controls the drive control unit 42 and the print control unit 43. The central control unit 41 outputs a recording data signal supplied from the interface unit 31 to the drive control unit 42 and an image data signal supplied from the interface unit 31 to the print control unit 43. The central control unit 41 carries out disc correlating processing described later based on a specified address signal supplied from the drive control unit 42 and an encoder signal supplied from the encoder sensor 22.

The drive control unit 42 outputs a control signal to the motor driving circuit 33 to control the rotation of the spindle motor 2 and a pickup driving motor, not shown. The drive control unit 42 outputs a control signal to the optical pickup 3 to control a tracking servo and a focusing servo so that the light beam emitted from the optical pickup 3 follows a track on the optical disc 101. Also, the drive control unit 42 outputs the specified address signal supplied from the signal processing unit 6 to the central control unit 41.

The recording control circuit 32 carries out processes such as encoding and modulating of the reproduced data signal supplied from the drive control unit 42 and outputs the processed reproduced data signal to the drive control unit 42. The motor driving circuit 33 drives the spindle motor 2 based on a control signal supplied from the drive control unit 42. As a result, the optical disc 101 on the turntable 11 of the spindle motor 2 is rotated. The motor driving circuit 33 drives the pickup driving motor based on the control signal from the drive control unit 42. As a result, the optical pickup 3 is driven in the radial direction of the optical disc 101 together with the pickup base.

The signal processing unit 6 carries out such processing as demodulation and error detection on an RF (Radio Frequency) signal supplied from the optical pickup 3 to generate the reproduced data signal. The signal processing unit 6 generates the specified address signal in which one pulse is outputted when the optical pickup 3 reproduces a specified address on the information recording surface of the optical disc 101. The signal processing unit 6 also outputs the reproduced data signal and the specified address signal to the drive control unit 42.

The specified address is one address out of a plurality of addresses recorded on the information recording surface of the optical disc 101 and the position where such address is recorded is regarded as a base position (hereinafter referred to as the “disc base position 45”) of the optical disc 101. Note that although it is preferable to set the same specified address on different types of optical discs, such address may be set differently for each type of optical disc.

The print control unit 43 controls the print head 4, the head driving motor 15, and the like to have visible information printed on the label surface 101a of the optical disc 101. The print control unit 43 generates ink ejection data based on the image data signal supplied from the central control unit 41. The print control unit 43 generates control signals for controlling the print head 4 and the head driving motor 15 based on the generated ink ejection data and a position data signal showing position data of the optical disc 101 supplied from the central control unit 41, and outputs the control signals to the ink ejection driving circuit 35 and the head driving circuit 36.

The ink ejection driving circuit 35 drives the print head 4 based on the control signal supplied from the print control unit 43. As a result, ink droplets are ejected from the plurality of ejection nozzles of the print head 4 and dripped onto the label surface 101a of the rotating optical disc 101. The head driving circuit 36 drives the head driving motor 15 based on a control signal supplied from the print control unit 43. By driving the head driving motor 15, the print head 4 is moved in the radial direction of the optical disc 101.

Next, the disc correlating processing that correlates the disc base position 45 with the encoder signal will be described with reference to FIGS. 4 and 5. As shown in FIG. 4, when the optical disc 101 has been placed on the turntable 11 of the disc drive apparatus 1, the drive control unit 42 controls the spindle motor 2 to rotate the optical disc 101 (step S1). Then, the encoder sensor 22 outputs the encoder signal to the central control unit 41. The drive control unit 42 also controls the optical pickup 3 to continuously reproduce a specified address recorded on the information recording surface of the optical disc 101. Accordingly, the signal processing unit 6 generates the specified address signal and outputs the specified address signal to the central control unit 41.

Next, the central control unit 41 monitors the encoder signal supplied from the encoder sensor 22 at constant intervals (step S2). When the encoder home position 24 is detected from the monitored encoder signal (step S3), the central control unit 41 counts the number of pulses in the encoder signal (step S4). As shown in FIG. 5, although the pulses in the encoder signal rise at predetermined intervals, the interval during which no pulse rises is longer when the encoder home position 24 faces the sensing unit 25. By detecting this, the central control unit 41 can detect the encoder home position 24 from the encoder signal.

Next, the central control unit 41 monitors the specified address signal supplied from the signal processing unit 6 (step S5). When the disc base position 45 has been detected from the monitored specified address signal (step S6), the central control unit 41 stops counting the number of pulses in the encoder signal (step S7). As shown in FIG. 5, a pulse rises in the specified address signal when the optical pickup 3 reproduces the specified address of the disc base position 45. By detecting this, the central control unit 41 can detect the disc base position 45 from the specified address signal.

Next, the central control unit 41 stores the counted number of pulses in a memory, not shown (step S8). Here, as shown in FIG. 5, it is assumed that the number of pulses that the central control unit 41 counts until the disc base position 45 is detected following the detection of the encoder home position 24 is five. In this case, the optical disc 101 is rotating in a state where the disc base position 45 is displaced by five pulses from the encoder home position 24.

Accordingly, the central control unit 41 sets a virtual disc base position in the encoder signal at a position which is the sixth pulse (in this embodiment) after the detection of the encoder home position 24 (step S9). As a result, the central control unit 41 can grasp the absolute position of the optical disc 101 from the encoder signal. Consequently, the disc correlating processing that correlates the disc base position 45 and the encoder signal is completed.

After the disc correlating processing has been completed, the printing of the visible information on the label surface 101a of the system 100 is executed. Note that after the disc correlating processing has been completed, it is also possible to record (write) an information signal onto the information recording surface of the optical disc 101 or to reproduce (read) an information signal that has been recorded in advance.

Next, the procedure for printing visible information on the label surface 101a of the optical disc 101 by the disc drive apparatus 1 will be described. To print the visible information on the label surface 101a of the optical disc 101, first the drive control unit 42 controls the spindle motor 2 based on the encoder signal to rotate the optical disc 101 at a constant velocity. Based on the absolute position of the optical disc 101 detected from the encoder signal, the central control unit 41 generates a position data signal that shows position information for the optical disc 101 and outputs the position data signal to the print control unit 43.

Next, the print control unit 43 controls the ink ejection driving circuit 35 and the head driving circuit 36 based on the position data signal supplied from the central control unit 41 and the ink ejection data so that as shown in FIGS. 6A and 7A, visible information is printed on the label surface 101a of the optical disc 101. When doing so, since the print head 4 ejects the ink droplets on the label surface 101a of the optical disc 101 that is rotated at a constant velocity, the ejection timing of the ink droplets can be set at a constant timing, which means that control of the ink ejection driving circuit 35 and the head driving circuit 36 by the print control unit 43 can be simplified.

When the printing of visible information on the label surface 101a has been completed, the central control unit 41 outputs printed information about the printed visible information and the printed region(s) on the label surface 101a expressed relative to the disc base position 45 to the drive control unit 42. The drive control unit 42 controls the optical pickup 3 and the spindle motor 2 so that the printed region information is recorded on the information recording surface of the optical disc 101.

Subsequently, the optical disc 101 is ejected from the disc drive apparatus 1, and when the optical disc 101 is loaded back into the disc drive apparatus, the relative positions of the encoder home position 24 of the encoder disc 21 and the disc base position 45 of the optical disc 101 will have changed. For this reason, whenever the optical disc 101 is loaded, the central control unit 41 carries out the disc correlating processing to grasp the absolute position of the optical disc 101. After this, by reproducing the printed region information recorded on the information recording surface, it is possible to detect the absolute positions of the printed regions on the label surface 101a and as shown in FIGS. 6B and 7B, to additionally print on printable regions aside from the printed regions.

FIG. 8 is a block diagram for explaining a second embodiment of a disc drive apparatus according to the present invention, and showing the construction of a disc drive apparatus 51. The disc drive apparatus 51 has the same construction as the disc drive apparatus 1 according to the first embodiment, and the only difference to the disc drive apparatus 1 is a frequency generator (FG) 52 that is a second specific example of a pulse signal generating unit. Accordingly, the frequency generator 52 will be described, and components that are the same as in the disc drive apparatus 1 have been assigned the same reference numerals and description thereof has been omitted.

As shown in FIG. 8, the frequency generator 52 of the disc drive apparatus 51 is installed inside the spindle motor 2. The frequency generator 52 generates an FG pulse signal that is a second specific example of a pulse signal that corresponds to rotation of the spindle motor 2. That is, the FG pulse signal is a signal where a pulse is outputted when the spindle motor 2 rotates by a predetermined angle.

A Z phase signal output circuit 53 is also provided inside the spindle motor 2. The Z phase signal output circuit 53 generates a Z phase signal where one pulse is outputted whenever the spindle motor 2 makes one revolution. The Z phase signal is a signal for setting the base position of the spindle motor 2 and the position at which the pulse is outputted in the Z phase signal is set as a motor base position of the spindle motor 2. The frequency generator 52 and the Z phase signal output circuit 53 respectively output the FG pulse signal and the Z phase signal to the central control unit 41.

The central control unit 41 of the disc drive apparatus 51 carries out disc correlating processing that correlates the disc base position 45 and the FG pulse signal. The disc correlating process carried out by the disc drive apparatus 51 will now be described with reference to FIGS. 9 and 10. As shown in FIG. 9, once the optical disc 101 has been placed on the turntable 11 of the disc drive apparatus 51, the drive control unit 42 controls the optical pickup 3 and the spindle motor 2 to rotate the optical disc 101 and continuously reproduce the specified address (step S11). Then, the signal processing unit 6 generates the specified address signal and outputs the specified address signal to the central control unit 41. At the same time, the frequency generator 52 and the Z phase signal output circuit 53 respectively output the FG pulse signal and the Z phase signal to the central control unit 41.

Next, the central control unit 41 monitors the FG pulse signal supplied from the frequency generator 52 at constant intervals (step S12). After this, once the motor base position of the spindle motor 2 has been detected from the Z phase signal (step S13), the central control unit 41 counts the number of pulses in the FG pulse signal (step S14). As shown in FIG. 10, a pulse rises in the Z phase signal whenever the encoder disc 21 makes one revolution. The central control unit 41 detects the position where the pulse rises in the Z phase signal as the motor base position.

Next, the central control unit 41 monitors the specified address signal supplied from the signal processing unit 6 (step S15). After this, once the disc base position 45 has been detected from the monitored specified address signal (step S16), the central control unit 41 stops counting the number of pulses in the FG pulse signal (step S17). As shown in FIG. 10, a pulse in the specified address signal rises when the optical pickup 3 reproduces the specified address of the disc base position 45. By detecting this, the central control unit 41 can detect the disc base position 45 from the specified address signal.

Next, the central control unit 41 stores the counted number of pulses in a memory, not shown (step S18). Here, as shown in FIG. 10, it is assumed that the number of pulses that the central control unit 41 counts until the disc base position 45 is detected following the detection of the motor base position (i.e., the pulse in the Z phase signal) is five. In this case, the optical disc 101 is rotating in a state where the disc base position 45 is displaced by five pulses from the motor base position (the pulse in the Z phase signal).

Accordingly, the central control unit 41 sets a virtual disc base position in the FG pulse signal at a position which is the sixth pulse (in this embodiment) after the pulse corresponding to when the pulse was detected in the Z phase signal (step S19). As a result, the central control unit 41 can grasp the absolute position of the optical disc 101 from the FG pulse signal. By doing so, the disc correlating processing that correlates the disc base position 45 and the FG pulse signal is completed.

After the detection of the position of the optical disc 101 relative to the spindle motor 2 has been completed, the printing of visible information on the label surface 101a of the optical disc 101 is executed. Here, the central control unit 41 generates the position data signal showing position information for the optical disc 101 based on the absolute position of the optical disc 101 detected from the FG pulse signal and outputs the position data signal to the print control unit 43. Accordingly, the print control unit 43 can control the ink ejection driving circuit 35 and the head driving circuit 36 so that visible information can be printed on the label surface 101a of the optical disc 101.

When the printing of visible information on the label surface 101a has been completed, the central control unit 41 outputs printed information about the printed visible information and the printed region(s) on the label surface 101a expressed relative to the disc base position 45 to the drive control unit 42. The drive control unit 42 controls the optical pickup 3 and the spindle motor 2 so that the printed region information is recorded on the information recording surface of the optical disc 101.

Subsequently, the optical disc 101 is ejected from the disc drive apparatus 1, and when the optical disc 101 is loaded back into the disc drive apparatus, the relative positions of the motor base position of the spindle motor 2 and the disc base position 45 of the optical disc 101 will have changed. Accordingly, whenever the optical disc 101 is loaded, the central control unit 41 carries out the disc correlating processing to grasp the absolute position of the optical disc 101. Then, by reproducing the printed region information recorded on the information recording surface, it is possible to detect the absolute positions of the printed regions on the label surface 101a and to additionally print on printable regions aside from the printed regions.

Next, a third embodiment of a disc drive apparatus according to the present invention will be described. The disc drive apparatus according to the third embodiment has the same construction as the disc drive apparatus 1 according to the first embodiment, and the only differences to the disc drive apparatus 1 are an encoder disc 26 of an encoder 5a and the disc correlating processing. Therefore, the encoder disc 26 and the disc correlating processing will be described, and components that are the same as in the disc drive apparatus 1 have been assigned the same reference numerals and description thereof has been omitted.

As shown in FIGS. 11 and 12, the encoder disc 26 used in the disc drive apparatus according to the third embodiment is formed of a thin disc and a center thereof is fixed to the rotational shaft of the chucking plate 12. A slit 27 that extends in the radial direction is provided on the encoder disc 26. The position where the slit 27 is provided on the encoder disc 26 is set as an encoder home position 28 as one specific example of a signal generating unit base position. Accordingly, the sensing unit 25 of the encoder sensor 22 detects the slit 27 provided at the encoder home position 28 of the encoder disc 26 and generates an encoder signal with a rising pulse.

The disc drive apparatus according to the third embodiment carries out disc correlating processing that correlates the disc base position 45 and the encoder signal. The disc correlating processing carried out by the disc drive apparatus according to the third embodiment will now be described with reference to FIGS. 13 and 14.

As shown in FIG. 13, once the optical disc 101 has been loaded to the turntable 11 of the disc drive apparatus according to the third embodiment, the drive control unit 42 controls the spindle motor 2 to rotate the optical disc 101 at a constant velocity (step S21). Due to the spindle motor 2 being driven, the encoder sensor 22 outputs the encoder signal to the central control unit 41. The drive control unit 42 then controls the optical pickup 3 to continuously reproduce the specified address. Accordingly, the signal processing unit 6 generates the specified address signal and outputs the specified address signal to the central control unit 41.

Next, the central control unit 41 monitors the encoder signal supplied from the encoder sensor 22 at constant intervals (step S22). When an encoder home position 24 is detected from the monitored encoder signal (step S23), the central control unit 41 starts to measure time (step S24). As shown in FIG. 14, a pulse rises in the encoder signal E2 when the slit 27 of the encoder home position 28 faces the sensing unit 25. By detecting this, the central control unit 41 can detect the encoder home position 28 from the encoder signal E2.

Next, the central control unit 41 monitors the specified address signal supplied from the signal processing unit 6 (step S25). On detecting the disc base position 45 from the monitored specified address signal (step S26), the central control unit 41 stops measuring the time. As shown in FIG. 14, a pulse rises in the specified address signal when the optical pickup 3 reproduces the specified address of the disc base position 45. By detecting this, the central control unit 41 can detect the disc base position 45 from the specified address signal.

Next, the central control unit 41 stores the measured time in a memory, not shown (step S28). As shown in FIG. 14, the time measured between when the central control unit 41 detects the encoder home position 28 until the disc base position 45 is detected is referred to as “X(s)”. Here, in a state where the optical disc 101 is rotated at a predetermined velocity, the disc base position 45 will be a position X(s) after the encoder home position 28.

Accordingly, the central control unit 41 sets the virtual disc base position the measured time stored in step S28 after detection of the encoder home position 28 (step S29). As a result, the central control unit 41 can calculate the difference in angle (i.e., displacement angle) of the disc base position 45 relative to the encoder home position 28 based on the rotational velocity of the optical disc 101 and the measured time, and can therefore grasp the absolute position of the optical disc 101 from the encoder signal. By doing so, the disc correlating processing that correlates the disc base position 45 and the encoder signal is completed.

After the disc correlating processing has been completed, the printing of the visible information on the label surface 101a of the system 100 is executed. When doing so, the central control unit 41 generates a position data signal showing position information for the optical disc 101 based on the absolute position of the optical disc 101 detected from the encoder signal and outputs the position data signal to the print control unit 43. As a result, the print control unit 43 can control the ink ejection driving circuit 35 and the head driving circuit 36 so that visible information can be printed on the label surface 101a of the optical disc 101.

When the printing of visible information on the label surface 101a has been completed, the central control unit 41 outputs printed information about the printed visible information and the printed region(s) on the label surface 101a expressed relative to the disc base position 45 to the drive control unit 42. The drive control unit 42 controls the optical pickup 3 and the spindle motor 2 so that the printed region information is recorded on the information recording surface of the optical disc 101.

Subsequently, the optical disc 101 is ejected from the disc drive apparatus 1, and when the optical disc 101 is loaded back into the disc drive apparatus, the relative positions of the encoder home position 28 of the encoder disc 26 and the disc base position 45 of the optical disc 101 will have changed. For this reason, whenever the optical disc 101 is loaded, the central control unit 41 carries out the disc correlating processing to grasp the absolute position of the optical disc 101. After this, by reproducing the printed region information recorded on the information recording surface, it is possible to detect the absolute positions of the printed regions on the label surface 101a and to additionally print on printable regions aside from the printed regions.

Although the present embodiment is constructed so as to use the encoder 5a as the pulse signal generating unit and to grasp the absolute position of the optical disc 101 from the encoder signal outputted from the encoder 5a, the present invention is not limited to this. It is also possible to use a construction where a Z phase signal output circuit is used as the pulse signal generating unit for an embodiment of the present invention and the absolute position of the optical disc 101 is grasped from a Z phase signal outputted from the Z phase signal output circuit.

When the Z phase signal output circuit is used as the pulse signal generating unit, the central control unit 41 monitors the Z phase signal at constant intervals and starts to measure time on detecting a pulse in the Z phase signal. Next, the central control unit 41 monitors the specified address signal and stops measuring the time on detecting the disc base position 45 from the specified address signal. The central control unit 41 sets a virtual disc base position the measured time after detecting the pulse in the Z phase signal. As a result, the central control unit 41 can grasp the absolute position of the optical disc 101 from the Z phase signal.

As described above, according to the disc drive apparatus and the disc printing method of the embodiments of the present invention, since the disc correlating processing that correlates the pulse signal generated by the pulse generating unit and the disc base position of the information recording medium is carried out, it is possible to obtain position information on a disc-shaped recording medium from the pulse signal. As a result, it is possible to carry out printing by ejecting ink droplets onto the label surface of the rotating disc-shaped recording medium.

Even if the disc-shaped recording medium is repeatedly ejected from and loaded into the apparatus, it will always be possible to grasp the absolute position of the disc-shaped recording medium. By expressing the printed region(s) relative to the disc base position and recording such information on the information recording surface of the disc-shaped recording medium or in a memory of the control unit, it is possible to carry out additional printing on the label surface.

In addition, when printing is carried out on the label surface, since the control unit controls the rotational driving unit based on the pulse signal to rotate the disc-shaped recording medium, it is possible to stop the operation of the recording and/or reproducing unit and thereby reduce the power consumption.

The present invention is not limited to embodiments described above and shown in the drawings and can be subjected to various modifications without departing from the scope of the invention. For example, although constructions where printed information such as information on the printed regions on the label surface and visible information that has been printed is recorded on the information recording surface of a disc-shaped recording medium have been described in the above embodiments, it is possible to store the printed region information in a memory of the apparatus together with a serial number of the disc-shaped recording medium on which printing was carried out.

It should be understood by those skilled in the art that various modifications, combinations, sub-combinations and alterations may occur depending on design requirements and other factors insofar as they are within the scope of the appended claims or the equivalents thereof.

What is claimed is:

1. A disc drive apparatus comprising:
a rotational driving unit rotating a disc-shaped recording medium in which a plurality of addresses have been recorded on an information recording surface of the disc-shaped recording medium;
a recording and/or reproducing unit carrying out recording and/or reproduction of an information signal on the information recording surface of the disc-shaped recording medium rotated by the rotational driving unit;
a print head printing visible information by ejecting ink droplets onto a label surface of the disc-shaped recording medium rotated by the rotational driving unit;
a pulse signal generating unit detecting rotation of the rotational driving unit and generating a pulse signal;
a signal processing unit generating a specified address signal in which a pulse is generated when a specified address on the disc-shaped recording medium is reproduced by the recording and/or reproducing unit; and
a control unit carrying out, based on the pulse signal and the specified address signal, disc correlating processing that correlates a disc base position at which the specified address is recorded on the disc-shaped recording medium and the pulse signal to obtain position information for the disc-shaped recording medium from the pulse signal.

2. A disc drive apparatus according to claim 1, wherein
the control unit controls the recording and/or reproducing unit to record information on printed regions where the visible information is printed on the label surface of the disc-shaped recording medium, on the information recording surface of the disc-shaped recording medium.

3. A disc drive apparatus according to claim 1, further comprising a memory that stores information on printed regions where the visible information is printed on the label surface of the disc-shaped recording medium.

4. A disc drive apparatus according to claim 1, wherein
the control unit is operable when printing the visible information on the label surface of the disc-shaped recording medium, to control the rotational driving unit based on the pulse signal to rotate the disc-shaped recording medium at a constant velocity.

5. A disc drive apparatus according to claim 1,
wherein the pulse signal generating unit includes an encoder disc rotating in synchronization with the rotational driving unit and having a plurality of detection portions formed predetermined intervals apart in a direction of rotation thereof and an encoder sensor detecting the plurality of detection portions of the encoder disc and outputting a pulse signal, and
wherein the control unit detects a base position of the encoder disc from the pulse signal and then detects the disc base position from the specified address signal and carries out disc correlating processing based on a number of pulses in the pulse signal generated between detection of the base position of the encoder disc and detection of the disc base position.

6. A disc drive apparatus according to claim 1,
wherein the pulse signal generating unit includes a frequency generator that is installed in the rotational driving unit and outputs the pulse signal, and
wherein the control unit detects a rotational driving unit base position from a Z phase signal outputted by a Z phase signal output circuit provided in the rotational driving unit and then detects the disc base position from the specified address signal and carries out disc correlating processing based on a number of pulses in the pulse signal generated between detection of the rotational driving unit base position and detection of the disc base position.

7. A disc drive apparatus according to claim 1,
wherein the pulse signal generating unit includes an encoder disc rotating in synchronization with the rotational driving unit and having a single detection portion that extends toward a center of rotation and an encoder sensor detecting the detection portion of the encoder disc and outputting a pulse signal, and
wherein the control unit detects a base position of the encoder disc from the pulse signal and then detects the disc base position from the specified address signal and then carries out disc correlating processing based on a time required between detection of the base position of the encoder disc and detection of the disc base position.

8. A disc drive apparatus according to claim 1,
wherein the pulse signal generating unit is a Z phase signal output circuit installed in the rotational driving unit, and
wherein the control unit detects a rotational driving unit base position from a Z phase signal outputted by the Z phase signal output circuit and then detects the disc base position from the specified address signal and carries out disc correlating processing based on a time required between detection of the rotational driving unit base position and detection of the disc base position.

9. A disc printing method of printing visible information by rotating a disc-shaped recording medium, on an information recording surface of which a plurality of addresses have been recorded, using a rotational driving unit and ejecting ink droplets onto a label surface of the disc-shaped recording medium, the method comprising the steps of:
detecting rotation of the rotational driving unit and outputting a pulse signal;
outputting a specified address signal in which a pulse is generated when a specified address on the disc-shaped recording medium is reproduced;
carrying out, based on the pulse signal and the specified address signal, disc correlating processing that correlates a disc base position at which the specified address is recorded on the disc-shaped recording medium and the pulse signal;
obtaining position information for the disc-shaped recording medium from the pulse signal based on a processing result of the disc correlating processing; and
printing visible information on the label surface based on the position information of the disc-shaped recording medium.
